(19) United States
(12) Patent Application Publication
(10) Pub. No.: US 2007/0127160 A1
(43) Pub. Date: Jun. 7, 2007

(54) Method and apparatus for an actuator block used in a actuator assembly of a hard disk drive

(76) Inventors: Gregory Tran, Santa Clara, CA (US); Joseph Chang, San Jose, CA (US); Shiao-Hua Chen, Palo Alto, CA (US); Tho Pham, Milpitas, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/297,874

(22) Filed: Dec. 7, 2005

(51) Int. Cl. G11B 5/55

(52) U.S. Cl. 360/265.7

(57) ABSTRACT

An actuator block including at least one slot between each adjacent pair of actuator arms and located behind a site for a flexure stiffener. The resulting hard disk drive shows an improved NRRO. The invention further includes the actuator block including two of the slots between each adjacent pair of actuator arms. The invention includes an actuator assembly formed from the actuator block coupling to at least one head gimbal assembly on each actuator arm. The actuator assembly further includes a main flexure coupling through the flexure stiffener to the actuator block. The invention further includes the hard disk drive including the actuator assembly. The invention includes making the actuator assembly from the actuator block and the hard disk drive from the actuator assembly. The actuator assembly and the hard disk drive are products of these processes.

### TECHNICAL FIELD

This invention relates to hard disk drive components, in particular, to the actuator block coupling at least two actuator arms in the hard disk drive.

### BACKGROUND OF THE INVENTION

Contemporary hard disk drives include a voice coil motor driving an actuator assembly, pivoting through an actuator pivot, to position one or more read-write heads, embedded in sliders, each over a rotating disk surface. The data stored on the rotating disk surface is typically arranged in concentric tracks. To access the data of a track, a servo controller first positions the read-write head by electrically stimulating the voice coil motor, which couples through the voice coil, actuator block, and an actuator arm to move a head gimbal assembly in positioning the slider close to the track. The read-write head is embedded in the slider. The focus of this invention is on the actuator block coupling at least two actuator arms in the actuator assembly, and its optimization to solve a previously overlooked problem in positioning the slider close to the track.

The positioning the slider close to a track is often referred to as the track following process. The disk surface is prepared for use as a data storage device, by first recording what are known as servo-track patterns. The data tracks are then recorded over the servo-tracks. The servo track signals are used to produce a Position Error Signal (PES). The Position Error Signal is used as a feedback signal informing the servo controller how close the read-write head actually is to the track.

Typically, during track following, the Position Error Signal contains two forms of errors. Repeatable Run-Out errors (RRO) are observed every time the track is accessed. These errors are often found to be related to the disk media or its movement, which may included mechanical vibrations originating in the spindle motor-spindle-disk coupling. Non-Repeatable Run-Out errors (NRRO) do not repeat every time the track is accessed. As such the causes of these errors are much more subtle diagnose. Insights have been needed into the causes of NRRO, and with these insights, solutions to the problems causing NRRO.

### SUMMARY OF THE INVENTION

The invention includes an actuator block including at least one slot between each adjacent pair of actuator arms and located behind a site for a flexure stiffener. The resulting hard disk drive shows an improved NRRO.

The invention further includes the actuator block including two of the slots between each adjacent pair of actuator arms. The actuator block includes at least two actuator arms. The actuator block may include more than two actuator arms.

The invention includes an actuator assembly formed from the actuator block coupling to at least one head gimbal assembly on each actuator arm. The actuator assembly further includes a main flexure coupling through the flexure stiffener to the actuator block. The invention further includes the hard disk drive including the actuator assembly.

The invention includes making the actuator assembly from the actuator block and the hard disk drive from the actuator assembly. The actuator assembly and the hard disk drive are products of these processes.

### BRIEF DESCRIPTION OF THE DRAWINGS

FIGS. 1A and 1B show a prior art actuator block;

FIGS. 1C to 1I show various embodiments of the actuator block of the invention;

FIG. 1J summarizes some of the experimental results regarding the invention's hard disk drives; and

FIG. 3 shows some exemplary details of the actuator assembly and the hard disk drive of the invention.

### DETAILED DESCRIPTION

This invention relates to hard disk drive components, in particular, to an actuator block coupling at least two actuator arms in the hard disk drive.

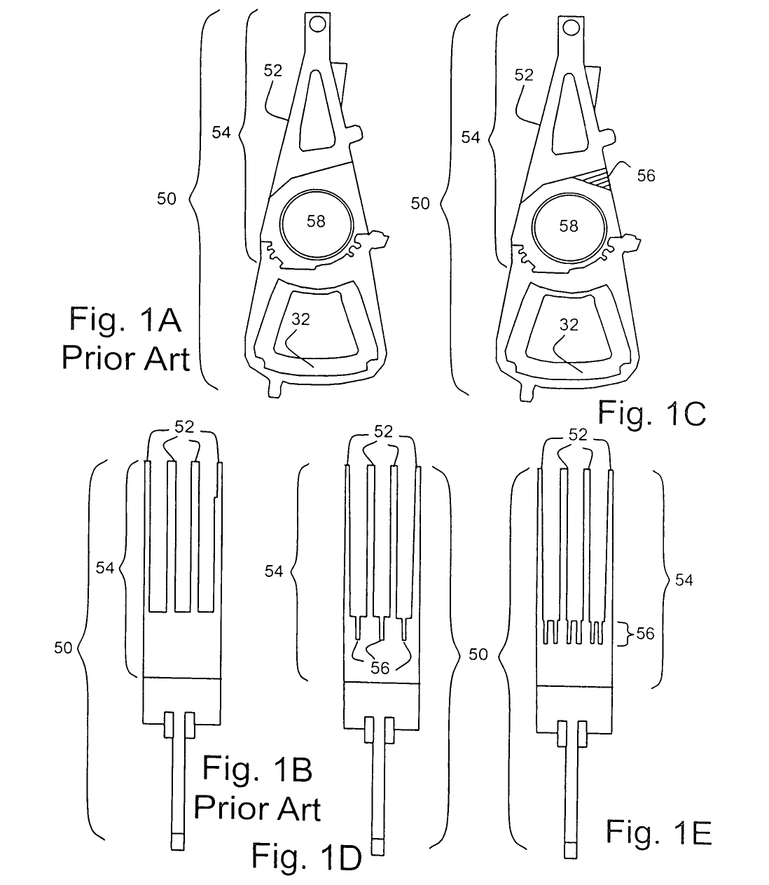

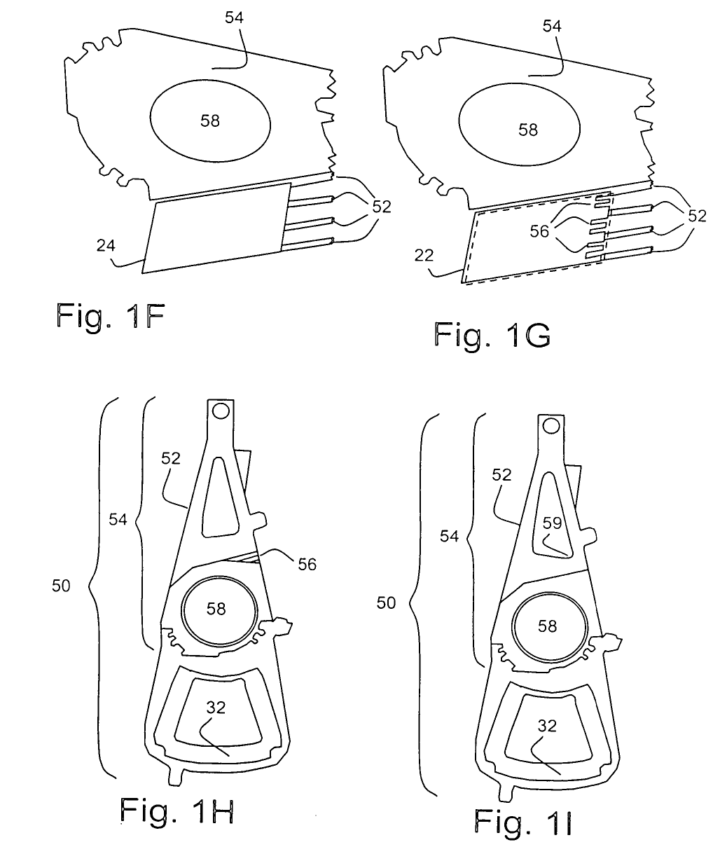

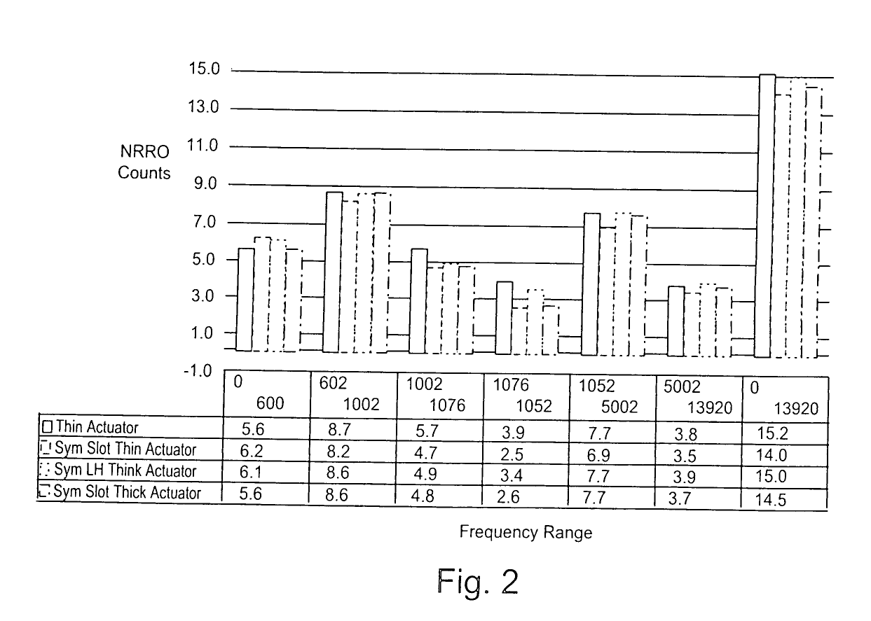

The invention includes the actuator block 54 including at least one slot 56 between each adjacent pair of actuator arms 52 and located behind a site 22 for a flexure stiffener 24, as shown in FIGS. 1C to 1H. The resulting hard disk drive shows an improved NRRO, which will be discussed through the use of FIG. 2. FIG. 1D shows the actuator block with one slot between the pairs of adjacent actuator arms. The invention further includes the actuator block including two of the slots between each adjacent pair of actuator arms, as shown in FIGS. 1E and 1G. The actuator block includes at least two actuator arms. The actuator block may include more than two actuator arms, as shown in the Figures.

The actuator arms were found to bend in some hard disk drives, causing a significant amount of NRRO. Experiments indicated that the arm bending could be attributed to imbalances in the actuator block. Placement of at least one triangular slot between each actuator arm in the actuator block reduced the contribution of arm bending on the NRRO while meeting the other constraints required for the actuator block.

In the present invention the problem has been reduced by placing at least one triangular slot 56 between each actuator arm 52 in the actuator block 54. The triangular configuration disclosed herein is one approach to reducing actuator arm bending effects on the NRRO. However, the configuration disclosed herein appears to work better than other configurations that have been tried, and also meets other constraints or practical limits required for use in commercially viable actuator blocks.

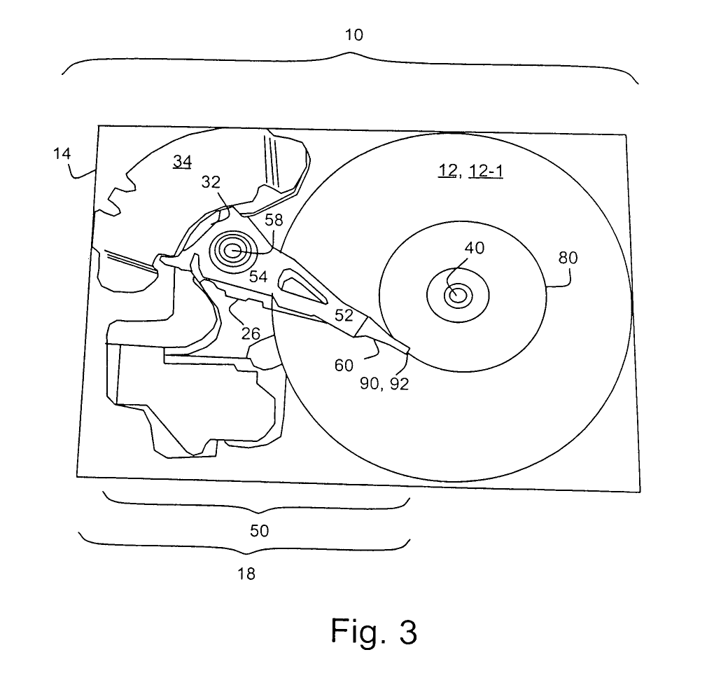

The invention includes an actuator assembly 50 formed from the actuator block 54 coupling to at least one head gimbal assembly 60 on each actuator arm 52, as in FIG. 3. The actuator assembly further includes a main flexure 26 coupling through the flexure stiffener 24 to the actuator block. The invention further includes the hard disk drive 10 including the actuator assembly 50.

The invention includes making the actuator assembly 50 from the actuator block 54 and the hard disk drive 10 from the actuator assembly 50. The actuator assembly 50 and the hard disk drive 10 are products of these processes. The hard disk drive is created by mounting the actuator assembly through its actuator pivot 58 to a disk base 14.

The actuator assembly 50 includes a voice coil 32 coupled to the actuator block. Each actuator arm 52 is coupled to at least one head gimbal assembly 60. Each head gimbal assembly includes a slider 90 with a read-write head 92 embedded in it. The read-write heads during normal operation float on an air bearing a short distance away from the rotating disk surface.

The hard disk drive 10 operates as follows. The disk 12 is rotated through the spindle 40 coupling to a spindle motor 42 to create the rotating disk surface 12-1. The voice coil motor 18 is controlled by a time varying electrical current applied to the voice coil 32. The interaction between the magnetic field induced by the voice coil and the fixed magnet 34 causes the actuator assembly 50 to pivot through the actuator pivot 58, moving each actuator arm 52 through lever action. This position the head gimbal assembly 60, and consequently the read-write head 92 over a track 80 on the rotating disk surface 12-1.

FIG. 2 shows some of the results of experiments performed by the inventors showing the improvement that adding at least one slot 56 brought to the hard disk drive. In these experiments, four distinct configurations of the actuator block were considered. All of the hard disk drives has three disks, and six read/write heads. The “Thin Actuator” has a top and a bottom actuator arm 52 of thickness 1.05 millimeters (mm) and middle actuator arms of thickness 1.24 mm. The Symmetric Slot Thin Actuator has the same thickness for each corresponding actuator arm and two small cut slots between each adjacent pair of actuator arms, as shown in FIG. 1H. The hard disk drives with actuator blocks including the deep cut slots as shown in FIG. 1C did not perform as well as the shallow cut slots, and are not shown in these performance Figures. The symmetric lightening hole thin actuator has the small cut 56 of FIG. 1H, with the same thickness for the actuator arms, and a lightening hole 59 as shown in FIG. 1I. The symmetric slot thick actuator refers to a hard disk drive with the symmetric slots as in FIG. 1H, with the top and the bottom actuator arm having a thickness of 1.13 mm and the middle actuator arms having a thickness of 1.34 mm. The experimental results indicate that the symmetric slot thin actuator hard disk drive has the smallest NRRO counts in each Frequency Range.

[Inventors] What are the units of the NRRO counts?

The preceding embodiments provide examples of the invention and are not meant to constrain the scope of the following claims.

What is claimed is:

1. An actuator block for a hard disk drive, comprising:
at least two actuator arms;
at least one slot between each two adjacent said actuator arms, and behind a site for a flexure stiffener.

2. The actuator block of claim 1, comprising two of said slots between each of said two adjacent actuator arms.

3. The actuator block of claim 1, comprising at least three of said actuator arms.

4. An actuator assembly, comprising: said actuator block of claim 1 coupling at least one head gimbal assembly to said actuator arm, for each of said actuator arms included in said actuator block.

5. The actuator assembly of claim 4, further comprising: said flexure stiffener coupling to said site for said flexure stiffener; and a main flexure coupling to said flexure stiffener.

6. A method of making the actuator assembly of claim 4, comprising the steps: coupling said actuator arm to at least one of said head gimbal assemblies, for each of said actuator arms included in said actuator block to create said actuator assembly.

7. The method of claim 6, further comprising the step: coupling a main flexure via said flexure stiffener to said site of said flexure stiffener to at further create said actuator assembly.

8. The actuator assembly as a product of the process of claim 6.

9. A hard disk drive, comprising said actuator assembly of claim 4.

10. A method of making said hard disk drive, comprising the step:
mounting said actuator assembly via an actuator pivot to a disk base to create said hard disk drive.

11. The hard disk drive, as a product of the process of claim 10.
